(19) United States
(12) Patent Application Publication
(10) Pub. No.: US 2014/0052977 A1
(43) Pub. Date: Feb. 20, 2014

(54) ELECTRONIC APPARATUS AND METHOD FOR BOOTING THE SAME

(71) Applicant: NUVOTON TECHNOLOGY CORPORATION, Hsinchu (TW)

(72) Inventors: Chia-Ching LU, Hsinchu City (TW); Shih-Hsuan YEN, Hsinchu (TW)

(73) Assignee: NUVOTON TECHNOLOGY CORPORATION, Hsinchu (TW)

(21) Appl. No.: 13/802,803

(22) Filed: Mar. 14, 2013

(30) Foreign Application Priority Data
Aug. 14, 2012 (TW) 101129389

(51) Int. Cl. G06F 9/44

(52) U.S. Cl. CPC G06F 9/4401
USPC 713/2

(57) ABSTRACT

An electronic apparatus includes an operating system and a control circuit. The operating system is driven by an output command signal to execute one of plural different boot procedures. The control circuit detects an input command signal correspondingly generated when a power push-button is pressed down in a condition of the operating system being deactivated, and generates the output command signal according to the detected input command signal. Moreover, a method for booting an electronic apparatus is also disclosed herein.

### RELATED APPLICATIONS

This application claims priority to Taiwan Application Serial Number 101129389, filed Aug. 14, 2012, which is herein incorporated by reference.

### BACKGROUND

1. Field of Invention

The present invention relates to an electronic apparatus. More to particularly, the present invention relates to an electronic apparatus capable of turning on an operating system.

2. Description of Related Art

A general booting procedure of an electronic apparatus (e.g., a personal computer, tablet computer, handheld device or the like) follows the steps of pressing a power push-button by a user and then loading a default operating system of the electronic apparatus to finish the procedure. Currently, some electronic apparatuses have the operating system with different default booting modes or procedures, such as a general system booting, an advanced system booting, and a system recovery booting, etc, allowing the users to choose their desired booting modes.

However, for those electronic apparatuses with different booting modes or procedures, the users have to choose which booting mode to be performed through keyboards or mice by pressing the power push-buttons, so as to boot up and provide electricity to the electronic apparatuses. It is inconvenient for the operation and easily for the users to make an incorrect selection.

Furthermore, concerning the requirements of higher and higher booting speed for the electronic apparatuses, the users have less and less time to choose a desired system mode in time before the electronic apparatuses load their default operating systems, so as to cause an inconvenient experience of use.

### SUMMARY

An aspect of the invention is related to a method for booting an electronic apparatus which includes detecting an input command signal correspondingly generated when a power push-button is pressed down in a condition of an operating system being deactivated; generating an output command signal according to the detected input command signal and executing one of plural different booting procedures corresponding to the input command signal through the operating system driven by the output command signal.

Another aspect of the invention is related to an electronic apparatus which includes an operating system and a control circuit. The operating system is driven by an output command signal for executing one of plural different booting procedures. The control circuit is configured to detect an input command signal correspondingly generated when a power push-button is pressed down in a condition of the operating system being deactivated and generating the output command signal according to the detected input command signal.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a circuit diagram of an electronic apparatus according to an embodiment of the invention.

FIG. 2 illustrates a flowchart of a method of generating an input command signal PSIN and an output command signal PSOUT under different booting modes according to an embodiment of the invention.

FIG. 3A illustrates a diagram of the input command signal PSIN and output command signal PSOUT under a first booting mode according to an embodiment of the invention.

FIG. 3B illustrates a diagram of the input command signal PSIN and output command signal PSOUT under a second booting mode according to an embodiment of the invention.

FIG. 3C illustrates a diagram of the input command signal PSIN and output command signal PSOUT under a third booting mode according to an embodiment of the invention.

FIG. 3D illustrates a diagram of the input command signal PSIN and output command signal PSOUT under the third booting mode according to another embodiment of the invention.

FIG. 3E illustrates a diagram of the input command signal PSIN and output command signal PSOUT under a fourth booting mode according to an embodiment of the invention.

FIG. 4 illustrates a flowchart of a method for generating the identified output command signal PSOUT under a booting mode according to an embodiment of the invention.

FIG. 5 illustrates a booting flowchart according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated, or meaning other approximate values.

It will be understood that, although the terms first, second, third, and fourth may be used herein to describe various elements, components, regions, layers and/or sections, these elements, components, regions, layers and/or sections should not be limited by these terms. These terms are only used to distinguish one element, component, region, layer or section from another.

In the following description and claims, the terms “coupled” and “connected,” along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

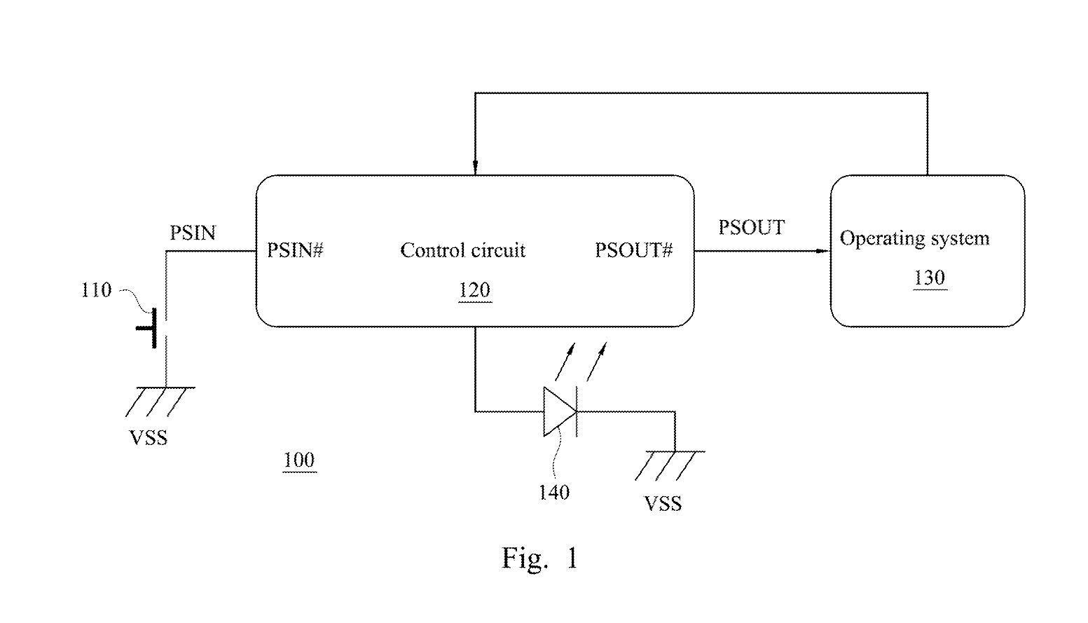

FIG. 1 illustrates a circuit diagram of an electronic apparatus according to an embodiment of the invention. As shown in FIG. 1, an electronic apparatus to 100, for example, a personal computer, a tablet computer, a handheld device, or any other related device, includes a power push-button 110, a control circuit 120, and an operating system 130. The power push-button 110, which can be coupled between a low voltage level terminal VSS (e.g., ground terminal), and the control circuit 120 is used to be pressed down so that a corresponding input command signal PSIN is generated and transmitted to the control circuit 120. For example, when the power push-button 110 is being pressed down, the low voltage level terminal VSS is connected to the control circuit 120, so that the control circuit 120 receives a corresponding low voltage level signal (i.e., the input command signal PSIN) through an input command signal terminal PSIN#. The control circuit 120, which is coupled between the power push-button 110 and the operating system 130, is used to detect the input command signal PSIN correspondingly generated when the power push button 110 is pressed down in a condition of the operating system 130 being deactivated (or referred to as power-off), and generates an output command signal PSOUT through an output command signal terminal PSOUT# according to the detected input command signal PSIN. The operating system 130 is preset to have different booting modes (for example, a general system booting mode, an advanced system booting mode, a system recovery booting mode etc.) and driven by the output command signal PSOUT generated by the control circuit 120 so that the input command signal PSIN executes one of a plurality of different booting procedures correspondingly.

Practically, the control circuit 120 may be a power management circuit or other circuits or elements with similar functions and operations. The control circuit 120 can be represented in the form of a single integrated circuit or located in an embedded controller, a super input/output (I/O) chip, or other controllers or chips. Furthermore, the operating system 130 may be a basic input/output system (BIOS). However, the control circuit 120 and the operating system 130 are not limited to those mentioned above.

In operation, when the output command signal PSOUT is generated, the control circuit 120 records status data corresponding to the input command signal PSIN (e.g., a flag) at the same time. The operating system 130 is used to access the corresponding status data from the control circuit 120, so that the operating system 130 executes one of the different booting procedures corresponding to the input command signal PSIN according to the accessed status data. In practice, the control circuit 120 records the status data through a register in it.

Furthermore, the electronic apparatus 100 further includes one or more light emitting element 140 which is related to the control circuit 120, so that the light emitting element 140 indicates a current booting mode or provides a system message (e.g., incorrect input command signal PSIN, signal retrieval failure, etc.) by showing different flashing frequency, luminous colors or other methods according to the status data recorded by the control circuit 120.

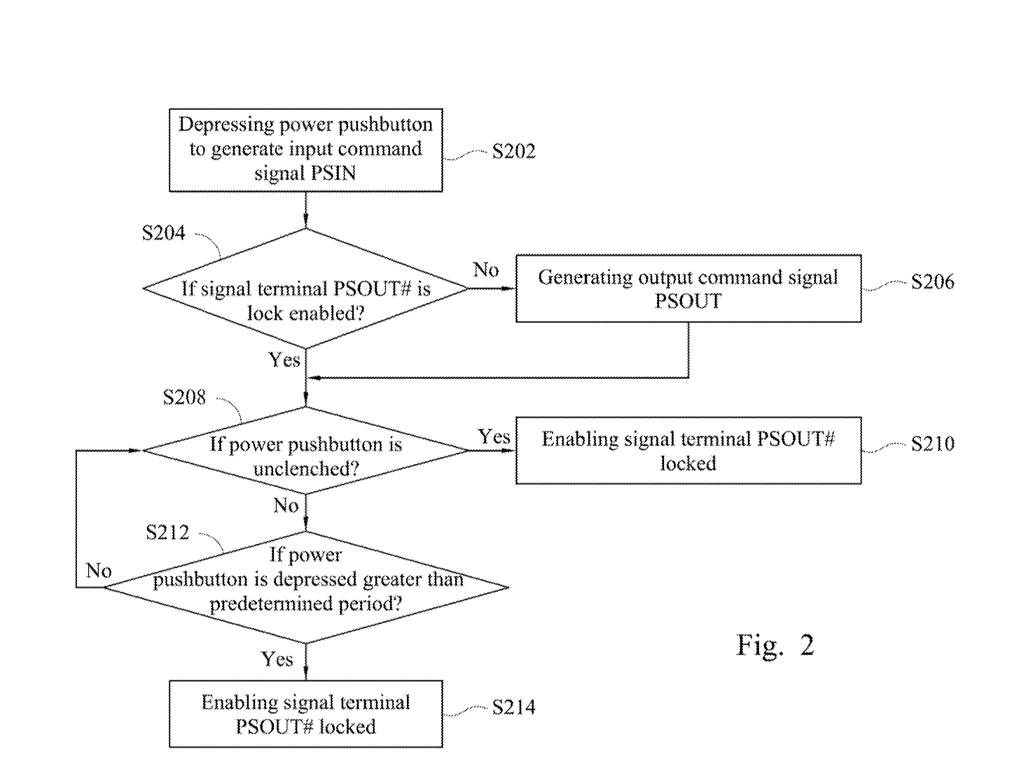

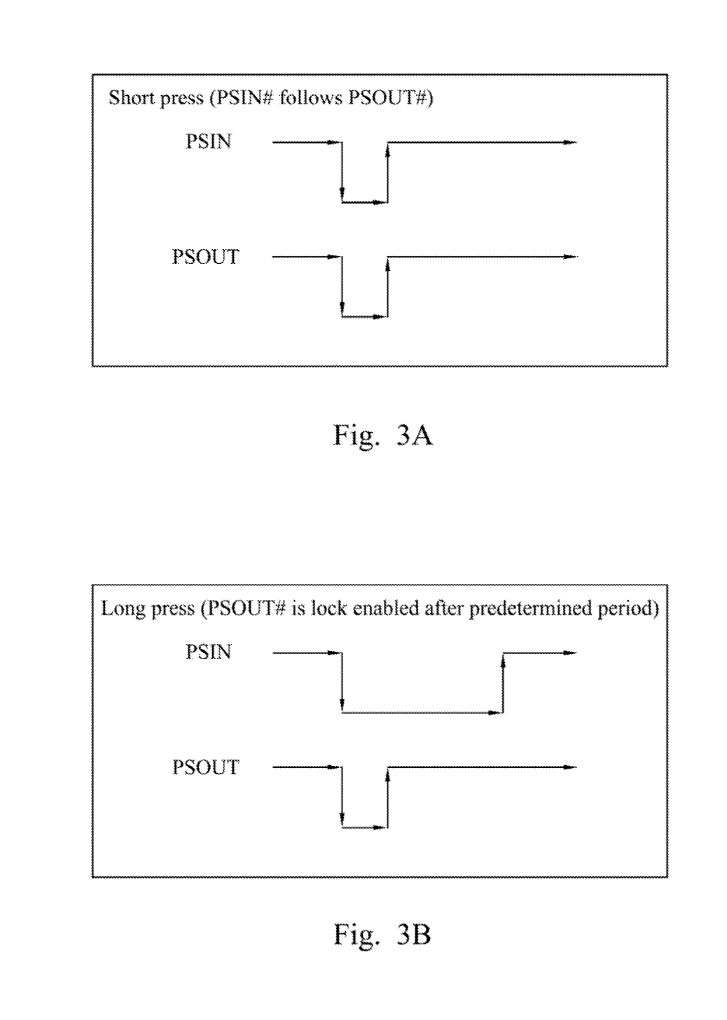

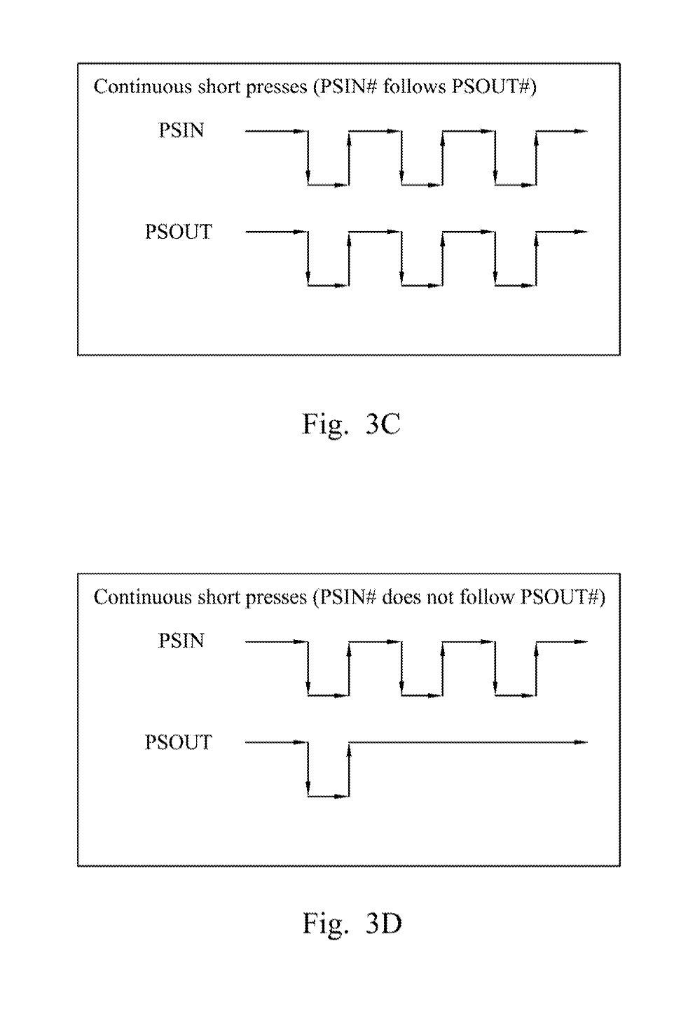

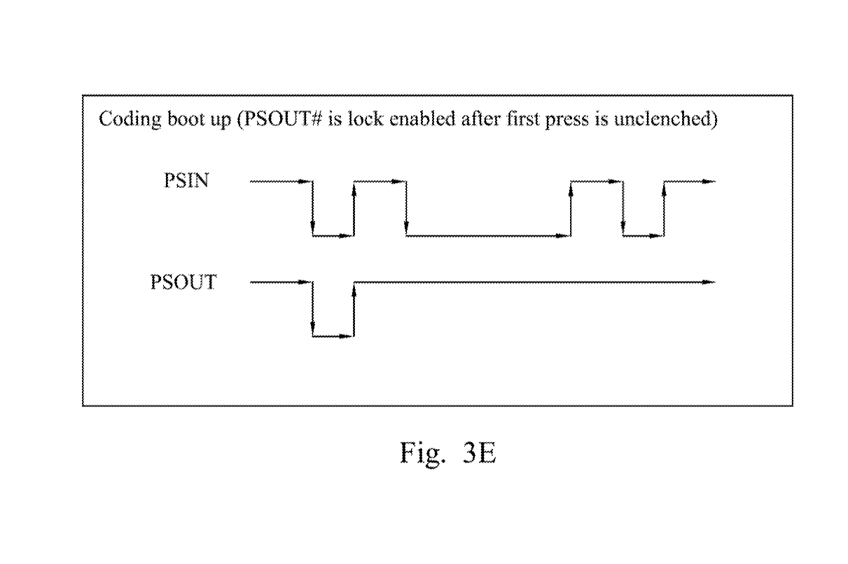

FIG. 2 illustrates a flowchart of a method of generating an input command signal PSIN and an output command signal PSOUT under different booting modes according to an embodiment of the invention. FIG. 3A illustrates a diagram of the input command signal. PSIN and the output command signal PSOUT under a first booting mode according to an embodiment of the invention. Please refer to FIGS. 1, 2, and 3A at the same time. At first, in step S202, the power push-button 110 is pressed down to generate the input command signal PSIN with a low voltage level in a condition of the operating system 130 being deactivated (or referred to as power-off) or a condition of an output command signal terminal PSOUT# remaining on a voltage level without being raised or reduced the voltage level by an input command signal terminal PSIN# (it is called “the signal terminal PSOUT# lock enable” in the disclosure).

Next, in step S204, whether the output command signal terminal PSOUT# is lock enabled or not is identified. If the signal terminal PSOUT# is not lock enabled (i.e., the voltage level of the signal terminal PSOUT# varies with the signal terminal. PSIN#), then in step S206, the output command signal PSOUT which varies with the input command signal PSIN and presents the low voltage level is generated. At this time, the operating system 130 is driven by the output command signal PSOUT to further execute corresponding booting procedures. In step S208, whether the power push-button 110 is unclenched or not is identified. If the power push-button 110 is unclenched, step S210 is executed, to transit the input command signal. PSIN from the low voltage level and to perform “lock enable” to the signal terminal PSOUT# so that the signal terminal PSOUT# returns back to a certain voltage level and does not vary with the signal terminal PSIN#, and the input command signal PSIN is also transited from the low voltage level.

FIG. 3A shows a condition representing an operating period of the input command signal PSIN corresponding to an operation of the power push-button 110 being pressed down for one time for a period which is less than or equal to a predetermined period (e.g., 1.5 sec.), and the operating period of the input command signal PSIN is the same as that of the output command signal PSOUT. In other words, the power push-button 110 is operated by “a short press” (the to term can be referred to as an operation of the power push-button being shortly pressed down for one time) to generate the output command signal PSOUT. The control circuit 120 records status data (e.g., the flag) corresponding to the input command signal PSIN through the operation of a “one-time short press”. The operating system 130 then accesses the corresponding status data from the control circuit 120 after being driven by the output command signal PSOUT, so that operating system 130 executes a booting procedure corresponding to the input command signal PSIN according to the accessed status data. The operating system 130 performs the first booting mode corresponding to the operation of the “one-time short press”.

FIG. 3B illustrates a diagram of the input command signal PSIN and output command signal PSOUT under a second booting mode according to an embodiment of the invention. Please refer to FIGS. 1, 2, and 3B at the same time. In step S204, if the output command signal terminal PSOUT# is lock enabled (i.e., the voltage level of the signal terminal PSOUT# does not vary with the signal terminal PSIN#), then whether the power push-button 110 is unclenched or not is identified (step S208). If the power push-button 110 is still being pressed down, then step S212 is executed, to further identify if the power push-button 110 is pressed down for a period greater than the predetermined period (e.g., 1.5 sec.). If the power push-button 110 is not pressed down for a period greater than the predetermined period, the process returns to step S208, to determine if the power push-button 110 is unclenched. On the contrary, if the power push-button 110 is pressed down for a period greater than the predetermined period, step S214 is executed, to perform ‘lock enable’ to the signal terminal PSOUT# so that the signal terminal PSOUT# returns back to a certain voltage level and does not vary with the signal terminal PSIN#, and the input command signal PSIN also transits from the low voltage level. Thus, the output command signal PSOUT can be avoided to stay on the low voltage level such that the operating system 130 shuts down again according to the output command signal PSOUT. For example, a computer will be turned off if the power push-button is pressed down for a period greater than 4 seconds (i.e., the output command signal PSOUT is on the low voltage level for a period greater than 4 seconds), in accordance with current computer system architecture.

FIG. 3B shows a condition representing an operating period of the input command signal PSIN corresponds to an operation of the power push-button 110 being pressed down for one time and is greater than the predetermined period (e.g., 1.5 sec.), and the operating period of the output command signal PSOUT is the predetermined period. In other words, the power push-button 110 is operated by a “one-time long press” (the term can be referred to as an operation of the power push-button 110 being long pressed down for one time) to generate the output command signal PSOUT. The control circuit 120 records the status data (e.g., the flag) corresponding to the input command signal PSIN through the operation of the “one-time long press”. The operating system 130 then accesses the corresponding status data from the control circuit 120 after being driven by the output command signal PSOUT, so that the operating system 130 executes the booting procedure corresponding to the input command signal PSIN according to the accessed status data. The operating system 130 performs the second booting mode corresponding to the operation of the “one-time long press”.

FIG. 3C illustrates a diagram of the input command signal PSIN and output command signal PSOUT under a third booting mode according to an embodiment of the invention. FIG. 3C shows a condition representing an operating period of the input command signal PSIN corresponds to an operation of the power push-button 110 being pressed down for continuous multiple times (e.g., the period of every press is less than or equal to the predetermined period), and the operating period of the output command signal PSOUT is the predetermined period (i.e., the signal terminal PSOUT# varies with the signal terminal PSIN#). In other words, the power push-button 110 is operated by “continuous short presses” (the term is referred to as an operation of the power push-button 110 being shortly pressed down for continuous times) to generate the output command signal PSOUT. The control circuit 120 records the status data (e.g., the flag) corresponding to the input command signal PSIN through the operation of the “continuous short presses.” The operating system 130 then accesses the corresponding status data from the control circuit 120 after being driven by the output command signal PSOUT, so that the operating system 130 executes the booting procedure corresponding to the input command signal PSIN according to the accessed status data. The operating system 130 performs the third booting mode corresponding to the operation of the “continuous short presses”.

FIG. 3D illustrates a diagram of the input command signal PSIN and output command signal PSOUT under the third booting mode according to another embodiment of the invention. Similarly, FIG. 3D shows a condition representing an operating period of the input command signal PSIN corresponds to an operation of the power push-button 110 being pressed down for multiple times (e.g., the period of every press is less than or equal to the predetermined period), and the operating period of the output command signal PSOUT only corresponds to an operation of the power push-button 110 being pressed down for a first one of multiple times (i.e., the signal terminal. PSOUT# does not vary with the signal terminal PSIN#). In other words, the power push-button 110 is operated by “continuous short presses” (the term can be referred to as an operation of the power push-button 110 being shortly pressed down for continuous times) to generate the output command signal PSOUT. The control circuit 120 records the status data (e.g., the flag) corresponding to the input command signal PSIN through the operation of the “continuous short presses”. The operating system 130 then accesses the corresponding status data from the control circuit 120 after being driven by the output command signal PSOUT, so that the operating system 130 executes the booting procedure corresponding to the input command signal PSIN according to the accessed status data. The operating system 130 performs the third booting mode corresponding to the operation of the “continuous short presses”.

FIG. 3E illustrates a diagram of the input command signal PSIN and output command signal PSOUT under a fourth booting mode according to an embodiment of the invention. FIG. 3E shows a condition representing an operating period of the input command signal PSIN corresponding to an operation of the power push-button 110 being pressed down for continuous multiple times (e.g., several short and long presses are operated in a regulated or unregulated order, it is called “continuous codes” operation here) with different durations, and the operating period of the output command signal PSOUT only corresponds to the operation of the power push-button 110 being pressed down to for a first one of multiple times (i.e., the signal terminal PSOUT# does not vary with the signal terminal PSIN#). In other words, the power push-button 110 is operated by the “continuous codes” to generate the output command signal PSOUT. The control circuit 120 records the status data (e.g., the flag) corresponding to the input command signal PSIN through the operation of the “continuous codes”. The operating system 130 then accesses the corresponding status data from the control circuit 120 after being driven by the output command signal PSOUT, so that the operating system 130 executes the booting procedure corresponding to the input command signal PSIN according to the accessed status data. The operating system 130 performs the fourth booting mode corresponding to the operation of the “continuous codes”.

Furthermore, based on the embodiments mentioned above, the control circuit 120 can further record the status data corresponding to the input command signal PSIN and read out the status data to generate a booting signal (in practice, the booting signal can be outputted accompanying with the output command signal PSOUT, or can be separated from output command signal PSOUT and generated by the control circuit 120), in which the booting signal represents a particular booting procedure of the above different booting procedures. The operating system 130 receives the booting signal and executes the particular booting procedure according to the booting signal, other words, the control circuit 120 can notify or instruct the operation system 130 to boot up in a particular booting form according to a retrieved result after reading the status data.

Moreover, in the condition of the control circuit 120 notifying or instructing the operating system 30 to boot up in the particular booting form the status data and the corresponded input command signal PSIN still can be generated according to different pressed down operations, such as those conditions shown in FIG. 3A to 3E.

On the other hand, in operation, the control circuit 120 can also be used to identify the detected input command signal PSIN and record the status data (e.g., the flag) corresponding to the input command signal PSIN according to an identified result, and generate the output command signal PSOUT after the corresponding status data are being recorded.

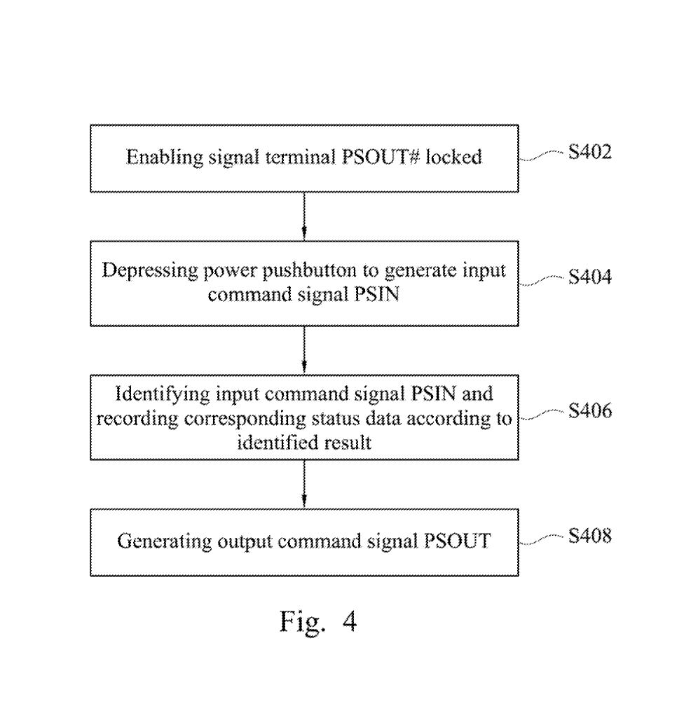

FIG. 4 illustrates a flowchart of a method for generating the identified output command signal PSOUT under a booting mode according to an embodiment of the invention. At first, under a shutdown condition, in step S402, the signal terminal PSOUT# is kept on a certain voltage level (i.e., the signal terminal PSOUT# is lock enabled), so that the signal terminal PSOUT# does not vary with the input command signal terminal PSIN#. Then in step S404, the power push-button 110 is pressed down to generate the input command signal PSIN. Next, the input command signal PSIN is identified by the control circuit 120 and the status data corresponding to the input command signal PSIN is recorded according to an identified result (step S406). Then in step S408, the output command signal PSOUT is generated by the control circuit 120 to drive the operating system 130. The related operations corresponding to the embodiments shown in FIG. 4 will be described with the conditions shown in FIG. 3A to 3E below for example.

Take the condition shown in FIG. 3A as an example, the control circuit 120 first identifies if the operating period of the input command signal PSIN corresponds to the operation of the power push-button 110 being pressed down for one time and is less than or equal to the predetermined period (e.g. 1.5 sec.), then the control circuit 120 records the corresponding status data according to the identified result and generates the output command signal PSOUT after the corresponding status data are recorded. The operating system 130 is used to access the status data from the control circuit 120 after being driven by the output command signal PSOUT, so that the operating system 130 performs the first booting mode which corresponds to the “one-time short press” operation. (In the embodiment described in FIG. 4, the output command signal PSOUT is not concurrently generated with the input command signal PSIN as shown in FIG. 3A to 3E but generated after the corresponding status data are recorded.)

Next, take the input command signal PSIN shown in FIG. 3B for example, the control circuit 120 first identify if the operating period of the input command signal PSIN corresponds to the operation of the power push-button 110 being pressed down for one time and is greater than the predetermined period (e.g. 1.5 sec.), then the control circuit 120 records the corresponding status data according to the identified result and generate the output command signal PSOUT after the corresponding status data are recorded. The operating system 130 is used to access the status data from the control circuit 120 after being driven by the output command signal PSOUT, so that the operating system 130 performs the second booting mode which corresponds to the “one-time long press” operation.

Moreover, take the condition shown in FIG. 3C for example, the control circuit 120 first identifies if the operating period of the input command signal PSIN corresponds to the operation of the power push-button 110 being pressed down for continuous multiple times and is greater than the predetermined period to (e.g. 1.5 sec.), then the control circuit 120 records the corresponding status data according to the identified result and generates the output command signal PSOUT after the corresponding status data are recorded. The operating system 130 is used to access the status data from the control circuit 120 after being driven by the output command signal PSOUT, so that the operating system 130 performs the third booting mode which corresponds to the “continuous short presses” operation.

Also, take the condition shown in FIG. 3E for example, the control circuit 120 first identifies if the operating period of the input command signal PSIN corresponds to the operation of the power push-button 110 being pressed down for continuous multiple times with different durations, then the control circuit 120 records the corresponding status data according to the identified result and generates the output command signal PSOUT after the corresponding status data are recorded. The operating system 130 is used to access the status data from the control circuit 120 after being driven by the output command signal PSOUT, so that the operating system 130 performs the fourth booting mode which corresponds to the “continuous codes” operation.

Furthermore, based on those previously described embodiments, the control circuit 120 can further be used in identifying the detected input command signal PSIN to generate a booting signal according to the identified result (in practice, the booting signal can be outputted accompanying with the output command signal PSOUT, or can be separated from output command signal PSOUT and generated by the control circuit 120), in which the booting signal represents a particular booting procedure of the above different booting procedures. The operating system 130 receives the booting signal and executes the particular booting procedure according to the booting signal. In other words, the control circuit 120 can notify or instruct the operation system 130 to boot up in a particular booting form according to a retrieved result after identifying the input command signal PSIN.

Moreover, the input command signal PSIN and its corresponding status data can also be generated according to the different pressed down operations as previously described conditions shown in FIG. 3A to 3E, so that the control circuit 120 is capable of notifying or instructing the operating system 130 to boot in the particular booting form.

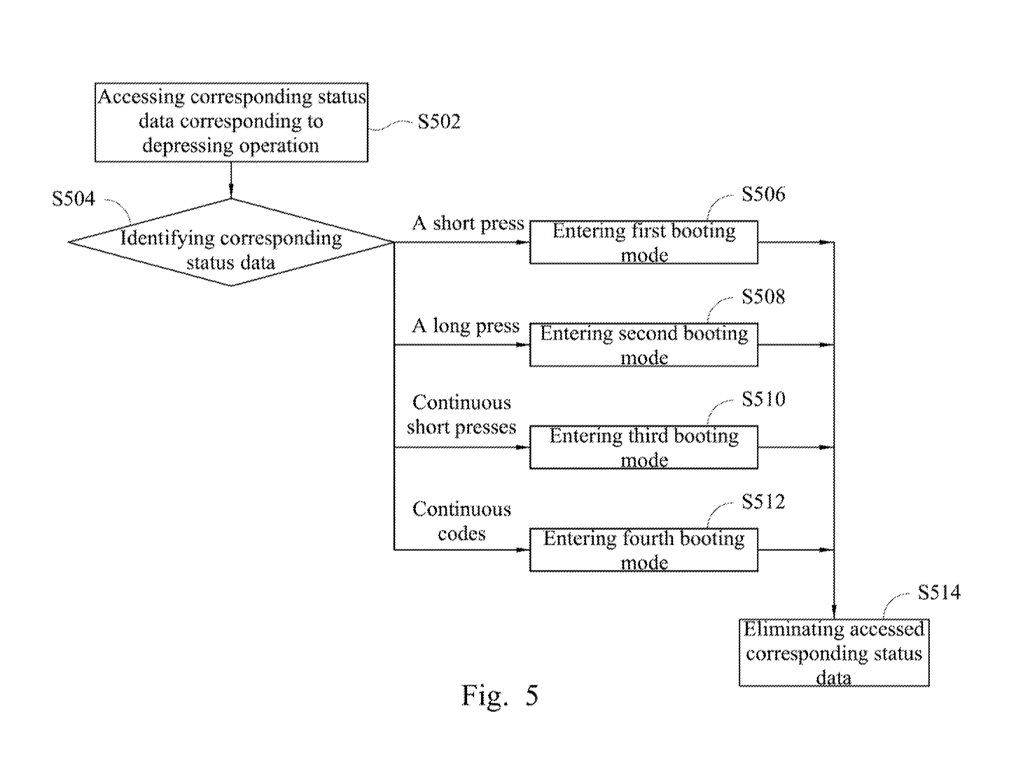

FIG. 5 illustrates a booting flowchart according to an embodiment of the invention. As shown in FIGS. 1 and 5, in step S502, the operating system 130 first accesses the corresponding status data (e.g., the flag) of the generated input command signal PSIN regarding to the pressed down operation from the control circuit 120 after driven by the output command signal PSOUT. Next, in step S504, the status data corresponding to the input command signal PSIN is identified by the operating system 130.

When the status data is the input command signal PSIN generated to correspond to the “one-time short press” operation, the operating system 130 executes the corresponding booting procedure according to the status data, performing the first booting mode corresponding to the “one-time short press” operation (step S506). When the status data is the input command signal PSIN generated to correspond to the “one-time long press” operation, the operating system 130 executes the corresponding booting procedure according to the status data, performing the second booting mode corresponding to the “one-time long press” operation (step S508). When the status data is the input command signal PSIN generated to correspond to the “continuous short presses” operation, the operating system 130 executes the corresponding booting procedure according to the status data, performing the third booting mode corresponding to the “continuous short presses” operation (step S510) When the status data is the input command signal PSIN generated to correspond to the “continuous codes” operation, the operating system 130 executes the corresponding booting procedure according to the status data, performing the fourth booting mode corresponding to the “continuous codes” operation (step S512). Next, in step S514, the corresponding status data accessed by the control circuit 120 are eliminated after the operating system 130 executes the corresponding booting procedure and finishes booting up for the future booting operation to access the corresponding status data.

As a result, no matter the control circuit 120 records the corresponding data while the output command signal PSOUT is being generated, or the control circuit 120 generates the output command signal PSOUT after identifying the booting mode and recording the corresponding status data, a user can press down the power push-button 110 in different ways to determine or choose a desired booting mode under the condition of the operating system 130 being deactivated (or referred to as “power-off”), without turning on an electronic device first and then choosing a booting mode to be performed through the operation of a keyboard or a mouse by the user. To operate the booting procedure becomes more convenient. The invention can also improve a condition that the user might choose an incorrect booting mode. Furthermore, since the previously described booting mode is held under a shutdown condition, it further improves the condition that the electronic apparatus loads a default system mode in the case of users not being able to choose a booting mode in time.

Although the present invention has been described in considerable detail with reference to certain embodiments thereof, other embodiments are possible. Therefore, the spirit and scope of the appended claims should not be limited to the description of the embodiments contained herein.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for booting an electronic apparatus, comprising:
detecting an input command signal correspondingly generated when a power push-button is pressed down in a condition of an operating system of the electronic apparatus being deactivated;
generating an output command signal according to the detected input command signal; and
executing one of a plurality of different booting procedures corresponding to the input command signal through the operating system driven by the output command signal.

2. The method of claim 1, further comprising:
recording status data corresponding to the input command signal when the output command signal is generated; and
accessing the status data corresponding to the input command signal, so that the operating system executes one of the different booting procedures corresponding to the input command signal according to the accessed status data.

3. The method of claim 2, wherein an operating period of the input command signal corresponds to an operation of the power push-button being pressed down for one time and is less than or equal to a predetermined period, and the operating period of the input command signal is the same as that of the output command signal.

4. The method of claim 2, wherein an operating period of the input command signal corresponds to an operation of the power push-button pressed down for one time and is greater than a predetermined period, and the operating period of the output command signal is the predetermined period.

5. The method of claim 2, wherein an operating period of the input command signal corresponds to an operation of the power push-button being pressed down for continuous multiple times, wherein the operating period of the output command signal is the same as the operating period of the input command signal, or the operating period of the output command signal only corresponds to the operation of the power push-button being pressed down for a first one of continuous multiple times.

6. The method of claim 2, wherein an operating period of the input command signal corresponds to an operation of the power push-button being pressed down for continuous multiple times with different durations, and the operating period of the output command signal only corresponds to the operation of the power push-button being pressed down for a first one of continuous multiple times.

7. The method of claim 1, the step of generating the output command signal according to the detected input command signal further comprising:
identifying the detected input command signal;
recording status data corresponding to the input command signal according to an identified result; and
generating the output command signal after the corresponding status data are being recorded.

8. The method of claim 7, wherein an operating period of the input command signal corresponds to an operation of the power push-button being pressed down for one time and is less than or equal to a predetermined period, and the operating system accesses the status data corresponding to the input command signal to execute one of the different booting procedures according to the accessed status data.

9. The method of claim 7, wherein an operating period of the input command signal corresponds to an operation of the power push-button being pressed down for one time and is greater than a predetermined period, and the operating system accesses the status data corresponding to the input command signal to execute one of the different booting procedures according to the accessed status data.

10. The method of claim 7, wherein an operating period of the input command signal corresponds to an operation of the power push-button being pressed down for continuous multiple times with same or different durations, and the operating system accesses the status data corresponding to the input command signal to execute one of the different booting procedures according to the accessed status data.

11. The method of claim 1, further comprising:
recording status data corresponding to the input command signal;
reading the status data to generate a booting signal, wherein the booting signal represents a specific booting procedure of the different booting procedures; and
receiving the booting signal and executing the specific booting procedure for the operating system of the electronic apparatus according to the booting signal.

12. The method of claim 1, further comprising:
identifying the detected input command signal;
generating a booting signal according to an identified result, wherein the booting signal represents a specific booting procedure of the different booting procedures; and
receiving the booting signal and executing the specific booting procedure for the operating system of the electronic apparatus according to the booting signal.

13. An electronic apparatus, comprising:
an operating system, driven by an output command signal, configured for executing one of a plurality of different booting procedures; and
a control circuit, configured for detecting an input command signal correspondingly generated when a power push-button is pressed down in a condition of the operating system being deactivated and generating the output command signal according to the detected input command signal.

14. The electronic apparatus of claim 13, wherein the control circuit is configured for recording status data corresponding to the input command signal when the output command signal is generated, and the operating system is configured for accessing the status data corresponding to the input command signal, so that the operating system executes one of the different booting procedures corresponding to the input command signal according to the accessed status data.

15. The electronic apparatus of claim 14, wherein an operating period of the input command signal corresponds to an operation of the power push-button being pressed down for one time and is greater than a predetermined period, and the operating period of the output command signal is the predetermined period.

16. The electronic apparatus of claim 14, wherein an operating period of the input command signal corresponds to an operation of the power push-button being pressed down for continuous multiple times, wherein the operating period of the output command signal is the same as the operating period of the input command signal, or the operating period of the output command signal only corresponds to the operation of the power push-button being pressed down for a first one of continuous multiple times.

17. The electronic apparatus of claim 14, wherein an operating period of the input command signal corresponds to an operation of the power push-button being pressed down for continuous multiple times with different durations, and the operating period of the output command signal only corresponds to the operation of the power push-button being pressed down for a first one of continuous multiple times.

18. The electronic apparatus of claim 13, wherein the control circuit is configured for identifying the detected input commend signal, recording status data corresponding to the input command signal according to an identified result, and generating the output command signal after the corresponding status data being recorded.

19. The electronic apparatus of claim 18, wherein an operating period of the input command signal corresponds to an operation of the power push-button being pressed down for one time and is greater than a predetermined period, and the operating system is configured for accessing the status data corresponding to the input command signal to execute one of the different booting procedures according to the accessed status data.

20. The electronic apparatus of claim 18, wherein an operating period of the input command signal corresponds to an operation of the power push-button being pressed down for continuous multiple times with same or different durations, and the operating system is configured for accessing the status data corresponding to the input command signal to execute one of the different booting procedures according to the accessed status data.
